(19) United States
(12) Patent Application Publication
(10) Pub. No.: US 2004/0248511 A1
(43) Pub. Date: Dec. 9, 2004

(54) Repeater for telecommunications network

(75) Inventor: Thomas Flynn, Laguna Beach, CA (US)

Correspondence Address: ORRICK, HERRINGTON & SUTCLIFFE, LLP, 4 PARK PLAZA, SUITE 1600, IRVINE, CA, 92614-2558, US

(73) Assignee: MPF Technologies Inc.

(21) Appl. No.: 10/458,807

(22) Filed: Jun. 9, 2003

(51) Int. Cl. H04B 3/36; H04B 7/14

(52) U.S. Cl. 455/7; 455/41.2; 455/90.3; 455/11.1

(57) ABSTRACT

A repeater system that is adapted to being mounted on a pole comprises a repeater unit, a first antenna and a second antenna. The repeater unit includes a repeater that is housed within a weatherproof enclosure. The enclosure includes two or more openings and defines an interior chamber or plenum which includes one or more cooling fans and heat sinks. The cooling fans motivate air within the plenum to cool the repeater and reduce the humidity within the plenum. The repeater system is dimensioned to meet the strict guidelines imposed by government regulations and/or pole owners regarding the size, surface area, weight and power requirements of such repeater systems.

### FIELD OF THE INVENTION

The invention is directed to repeater systems and methods for using repeater systems for telecommunications networks. More specifically, the invention is directed to repeater systems that facilitate communication within a telecommunication network while meeting strict size and weight regulations imposed on pole mounted repeater systems.

### BACKGROUND OF THE INVENTION

Large antennas used in mobile telecommunications networks may leave pockets or gaps that do not receive a sufficient signal. The signal may be deficient because of a complete lack of a signal or the signal is not of the required strength for adequate phone performance. Repeaters coupled with smaller antennas may be used to alleviate these problems by providing or boosting signal strength within the gaps. Repeaters equipped with one or more antennas serve as a receiver/relay transmitter and boost the signal strength by redirecting, filtering and amplifying the available signal.

It would be desirable to mount the repeaters to poles such as light standards. But because street light standard owners and/or city regulations have imposed restrictions on the mounting of repeater units on light standards, current repeaters cannot be mounted on light standards due to the size, weight and power consumption of current repeaters.

Restrictions on the repeater units typically include guidelines regarding the weight of the devices mounted to the light standard. For example, one municipality has imposed a weight limit of 20 pounds on equipment mounted to the pole of the light standard. Equipment that is mounted on the arm of the light standard cannot weigh more than 12 pounds. The surface area or wind area of the mounted equipment may also be regulated. For example, the regulations may require that all telecommunications equipment have a maximum surface area of 1 square foot on each side. Current systems typically cannot meet these regulations due to the size and weight of current components and corresponding cooling systems.

Regulations may also impose restrictions on the source and level of power use of the mounted telecommunications equipment. The regulations may require that the repeater system obtain power directly from the street lighting system. In addition, the equipment may be required to operate at or below a specified current level and/or have a maximum start up current level. Current systems typically do not meet these requirements.

Accordingly, an improved repeater system that can meet the weight, dimensional and power restrictions would be considered useful.

### SUMMARY OF THE INVENTION

The repeater system of the present invention is designed to be mounted on a pole such as a light standard and provides an improved design that is dimensioned to meet the strict size, weight and power requirements generally imposed by light standard owners and/or statutory regulations. The small size and low cost of the repeater system makes deployment of the repeater system very cost effective for telecommunications carriers. The repeater system generally comprises a repeater unit, a first antenna, and a second antenna.

The repeater unit includes an enclosure which houses cooling fans, heat sinks, a power regulator, and a radio amplifier or repeater. The total weight of the repeater unit is preferably less than about 20 pounds, and most preferably less than about 18 pounds. In addition, the surface area of the repeater unit is less than 1 square foot on each side. The enclosure typically comprises first and second enclosure bodies that may be joined together to form a sealed enclosure. The enclosure is typically mounted to the light standard pole by clamps, clips, tension bands or the like.

The enclosure defines a central channel that is dimensioned to receive the repeater and the power regulator. The enclosure also defines a U-shaped plenum or interior chamber that allows air to circulate within the enclosure. Cooling fans and heat sinks are disposed within the enclosure to further facilitate cooling of the repeater and power regulator and to reduce humidity within the enclosure. The enclosure may include two vented openings or apertures which allow air to enter and exit the enclosure. The cooling fans may be arranged such that one cooling fan motivates external air into the plenum and a second cooling fan motivates air out of the plenum.

The repeater unit further comprises a power plug receptor. A power cord may be inserted into the repeater unit to connect the repeater unit to a photocell adapter or other power source. The photocell adapter is configured to couple with the existing photocell of the light standard located above the light. The photocell adapter can then draw the power necessary to operate the repeater unit from the photocell.

The first antenna may be any type of antenna, and in a preferred embodiment is a directional or decibel antenna. The first antenna is in communication with the repeater via a first RF cable. The repeater unit may be configured to be coupled with the first antenna. When coupled, the combined weight of the repeater unit, first antenna, and the mounting brackets is preferably less than 20 pounds. In addition, the surface area of the first antenna and repeater unit when coupled does not exceed 1 square foot on any face.

The repeater system also includes a second antenna. The second antenna may be of any type, and in a preferred embodiment the second antenna is a yagi antenna. The second antenna may be mounted to the light standard arm by a second antenna bracket. Preferably, the weight of the second antenna is less than 3 pounds. The second antenna may be in communication with the repeater via a second RF cable. Preferably, the second RF cable and the power cord are secured to the light standard and/or light standard arm by a plurality of clamps, clasps, clips or the like.

In operation, one or more repeater systems are allocated onto a plurality of light standards to provide an increased signal to the surrounding area. The one or more repeater systems can be arranged to eliminate gaps in signal service or to boost signal strength in areas with an insufficient signal.

Other systems, methods, features and advantages of the present invention will be or will become apparent to one with skill in the art upon examination of the following figures and detailed description. It is intended that all such additional systems, methods, features, and advantages be included within this description, be within the scope of the invention, and be protected by the accompanying claims. It is also intended that features and aspects of each embodiment can be combined and integrated with those of other embodiments.

### BRIEF DESCRIPTION OF THE DRAWINGS

FIG. 1 is a side view of an exemplary embodiment of the present invention.

FIG. 2 is a side view of an exemplary embodiment of the present invention mounted to a light standard.

FIG. 3 is a schematic of an exemplary embodiment of the repeater unit of the present invention.

FIG. 4 is a detail side view of an exemplary embodiment of the present invention.

FIG. 5A is a front view of an exemplary embodiment of the repeater unit.

FIG. 5B is a bottom view of an exemplary embodiment of the repeater unit.

FIG. 6 is a view of an exemplary embodiment of the repeater unit.

FIG. 7 is a view of an exemplary embodiment of the first member of the enclosure of the repeater unit.

FIG. 8A is a back view of an exemplary embodiment of the first antenna of the present invention.

FIG. 8B is a front view of an exemplary embodiment of the first antenna of the present invention.

FIG. 9 is a detail top view of an exemplary embodiment of the first and second brackets which couple the first antenna and repeater unit.

FIG. 10 is a front view of an exemplary embodiment of the present invention.

FIG. 11 is a top view of an exemplary embodiment of the present invention.

FIG. 12 is a detail top view of an exemplary embodiment of a fastener of the present invention.

FIG. 13 is a schematic of an exemplary method of using the present invention.

FIG. 14 is a schematic of an exemplary embodiment of the monitoring system of the present invention.

### DETAILED DESCRIPTION OF THE PREFERRED EMBODIMENTS

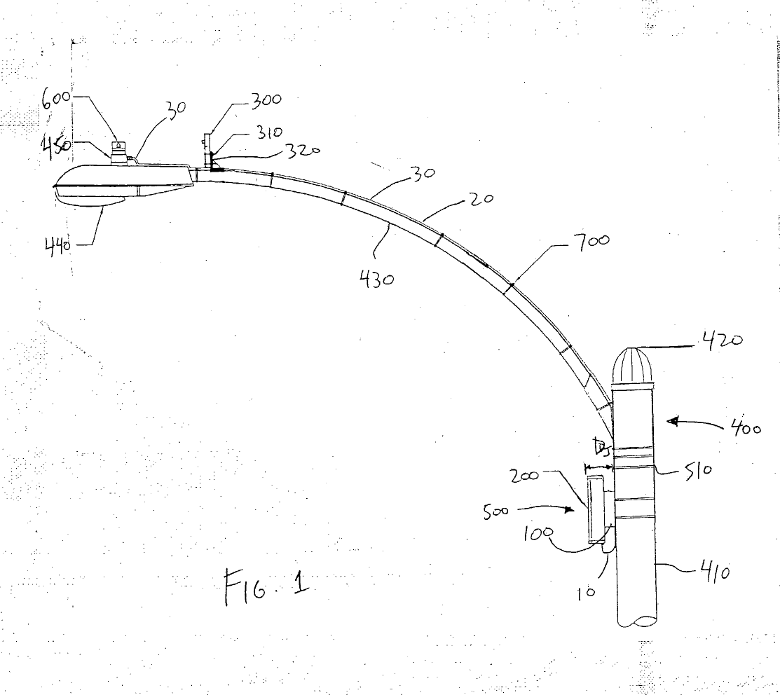

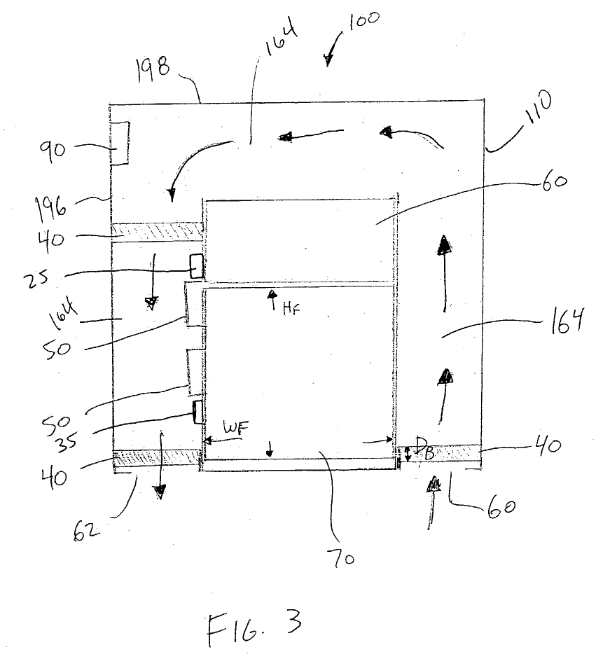

As depicted in the figures, the repeater system of the present invention may comprise a repeater unit 100, a first antenna 200 and a second antenna 300 (FIG. 1). The repeater system is dimensioned to meet applicable weight, surface area, and power restrictions that are imposed on mountable repeater systems. The repeater unit 100 of the present invention includes an enclosure 110 which houses the repeater 70. The enclosure 110 houses a repeater 70 and other electronic equipment within a weatherproof housing. The enclosure 110 is configured to define a plenum 164 (FIG. 3) which allows air motivated by one or more cooling fans to circulate within the enclosure 110 to cool the repeater 70 and other electronic equipment.

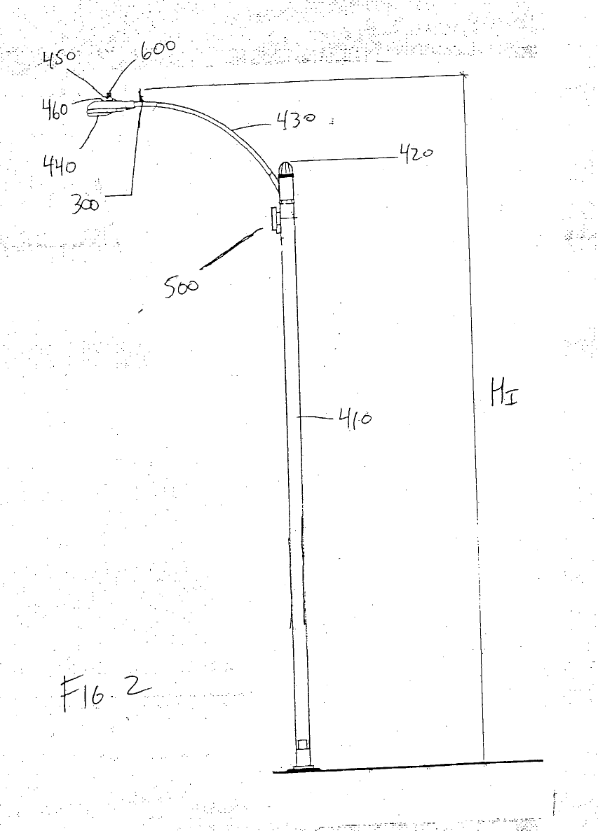

The repeater system is designed to be mounted on a pole such as a street light standard 400. The light standard 400 comprises a steel or concrete pole 410, a light standard arm 430 and a light 440. The light 440 may be a cobrahead luminaire or the like. The height H₁ of the light standard pole 410 may vary, but in general is in a range of about 20 to 40 feet (FIG. 2).

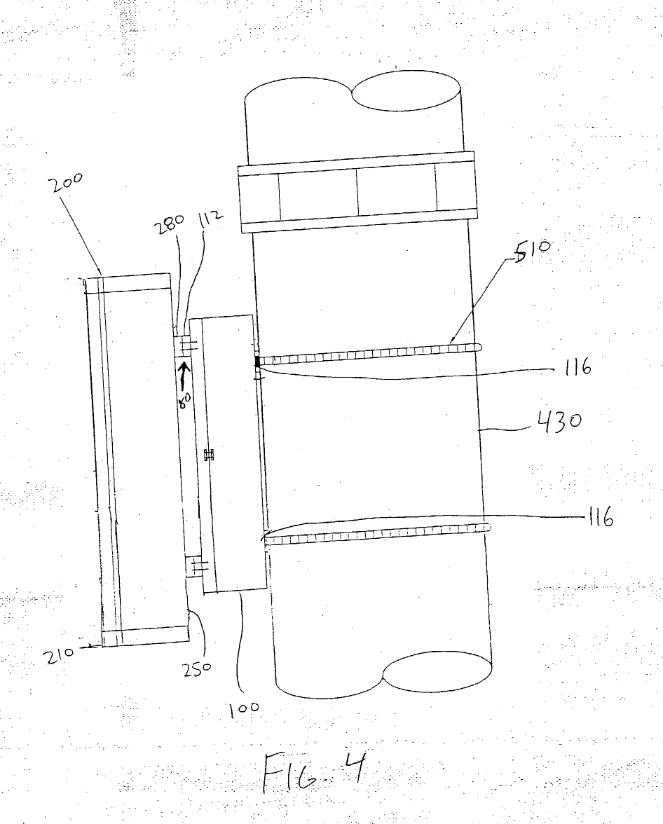

As shown in FIG. 3, the repeater unit 100 comprises an enclosure 110 which houses a plurality of cooling fans 40, one or more heat sinks 50, a power regulator 60 and a radio amplifier or repeater 70. In a preferred embodiment, the total weight of the repeater unit 110, including the mounting brackets 80 (FIG. 4), is less than about 20 pounds, and most preferably is less than about 18 pounds.

The repeater 70 and power regulator 60 may be of any form known in the art. Preferably, the repeater 70 has similar size and weight dimensions of an indoor repeater. As discussed further below, the enclosure 110 of the repeater system of the current invention creates the airflow needed to cool the repeater 70 to allow operation of such a repeater in an enclosure 110 made to withstand the outside environment.

The repeater 70 may be used for PCS, PCN, DCS-1800, or the like. The repeater 70 may be a single band repeater and/or be band specific. In a preferred embodiment, the repeater 70 preferably does not interfere with other carriers' networks. Preferably, the width W_{F} of the repeater 70 is between 4 and 10 inches (FIG. 3). The height H_{F} of the repeater 70 is preferably in the range of 4 and 10 inches. The depth (not shown) of the repeater 70 may vary, and is generally in the range of 1 to 4 inches. The weight of the repeater 70 is preferably less than about 5 pounds.

The repeater 70 includes a power adaptor (not shown) that is configured to connect the repeater 70 to an internal power cord (not shown). The internal power cord may connect the power adaptor of the repeater 70 with the power cord outlet 90. The power adaptor of the repeater 70 may be an AC/DC adaptor or a DC/DC adaptor. Preferably, the power adaptor is a 6.7 V/1.5 A AC/DC adaptor.

The repeater 70 may further include a manual and/or automatic gain and output power control (not shown). In a preferred embodiment, the repeater 70 operates at about 30 mW of power and between about 55 to 80 dB of gain. The gain and output power control can be adjusted by a user to reduce or eliminate osolation of the repeater unit. Osolation between repeater systems tends to occur if two repeater systems are mounted too close to each other. In this event, the power output of one or both repeater systems may be adjusted to reduce or eliminate osolation. In addition, the power output level can be adjusted based on the desired coverage area of the repeater system.

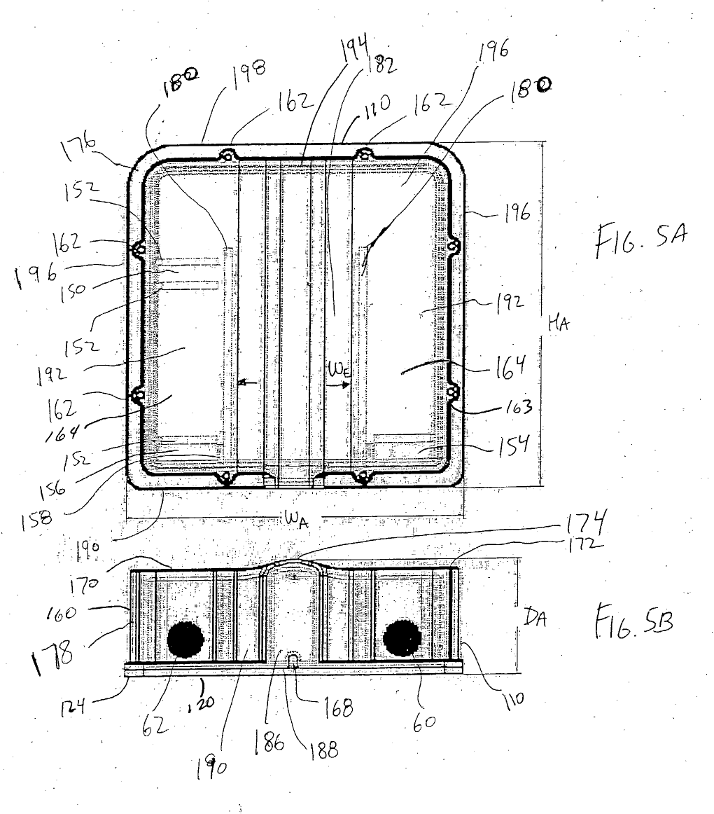

Turning to FIGS. 5A and 5B, the height H_{A} of the enclosure 110 of the repeater unit 100 is typically less than about 12 inches. Preferably, the height H_{A} of the enclosure is approximately 9.5 inches. The width W_{A} of the enclosure 110 is preferably less than 10 inches, and most preferably is approximately 9.2 inches. The depth D_{A} of the enclosure 110 is preferably in the range of about 2.5 to 4.5 inches.

The enclosure 110 may be comprised of any substantially rigid material such as plastic, metal, fiberglass or the like. The enclosure 110 may be any color. The enclosure 110 may be colored to match the light standard 400 and/or first antenna 200 or may be white, brown, gray, or beige.

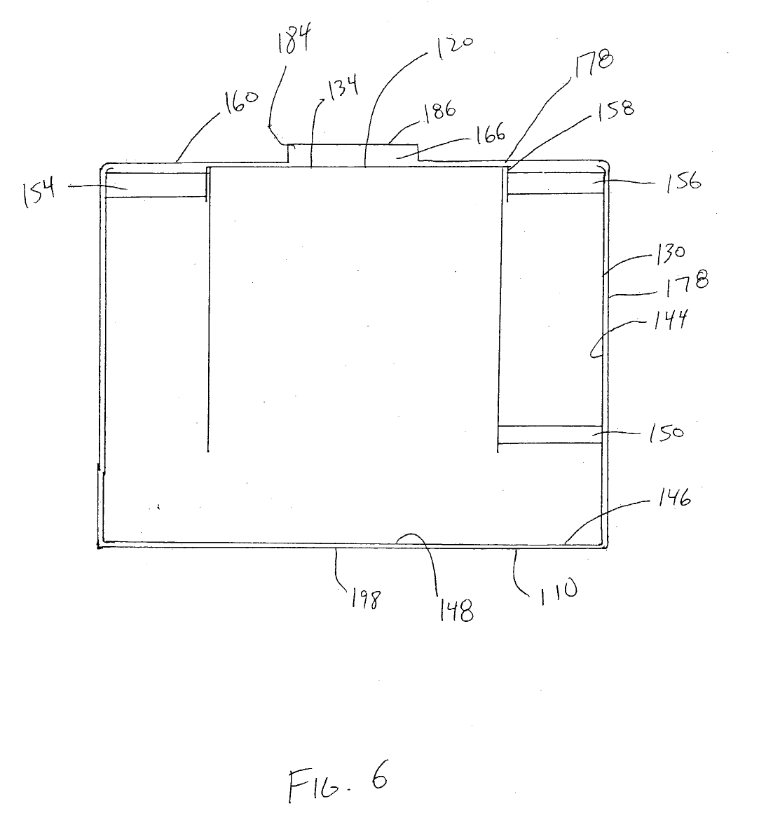

In a preferred embodiment, the enclosure 110 comprises a first member 120 and a second member 160 (FIG. 6). The first member 120 and the second member 160 are configured to mate or join. The first member 120 and the second member 160 comprise a plurality of apertures, openings or fastener channels 162 that are coextensive when the first member 120 and the second member 160 are joined together (FIG. 5A). A plurality of fasteners (not shown) may be inserted through the apertures 162 in order to secure the first member 120 and the second member 160 together. When joined, the first member 120 and second member 160 create a water tight enclosure 110.

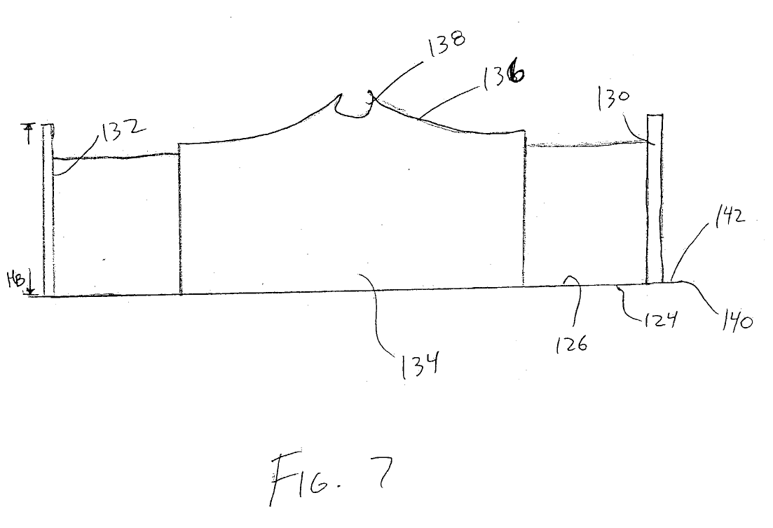

The first member 120 comprises a substantially flat back panel 124, an exterior wall 130, and a bottom wall 134 (FIGS. 5A, 5B and 7). The back panel 124 comprises a plurality of openings or apertures (not shown) that are configured to receive a fastener. As described further below, the apertures of the back panel 124 of the first member 120 are preferably aligned with fastener channels or openings 162 of the second member 160 such that a fastener may be inserted through openings, apertures, or fastener channels located on both the first member 120 and the second member 160.

The first member 120 typically comprises a U-shaped exterior wall 130 which is disposed substantially perpendicular to the back panel 124 (FIGS. 6 and 7). The exterior wall 130 is typically disposed inward from the apertures such that the exterior wall 130 is offset from the lateral edges 140 of the back panel 124 thereby defining a first horizontal lip 142. The exterior wall 130 extends along each side 144 of the first member 120 and the top portion 146 of the first member 120 (FIG. 6). The height H_{B} of the exterior wall 130 is generally uniform along each of the sides 144 of the first member (FIG. 7). The height H_{B} of the exterior wall 130 is preferably in the range of 0.5 to 3 inches. Preferably, the top portion 146 of the exterior wall 130 curves slightly upward near a central region 148 of the top portion 146 (FIG. 6). Therefore, the height of the exterior wall 130 in the central region 148 is typically greater than the height H_{B} of the exterior wall 130 along the sides 144 of the first member 120. The height of the exterior wall 130 in the central region 148 is preferably in a range of about 1 to 4 inches.

The first member 120 further comprises a bottom wall 134 having a substantially flat vertical surface (FIG. 7). The bottom wall 134 may include a curved central portion 136 which increases in height as compared to the sides of the bottom wall 134. The central portion 136 of the bottom wall 134 may further comprise a curved recess 138 that is configured to receive one or more RF cables 10, 20 which connect the antennas 200, 300 and the repeater 70 (FIGS. 1 and 7).

In a preferred embodiment, the first member 120 comprises a plurality of slots 150 configured to receive a cooling fan 40 (FIG. 5A). The cooling fan slots 150 generally include a pair of raised grooves 152 that extend along an upper face of the back panel 126 and an inner face of the exterior wall (FIG. 7). The raised grooves 152 thereby define a cooling fan slot 150 (FIG. 5A). The grooves 152 are dimensioned such that distance between the grooves 152 is slightly greater than the depth D_{B} of the cooling fan 70 (FIG. 3). The cooling fan slots 150 may be dimensioned based on the dimensions of the cooling fan 70 selected. In a preferred embodiment, the first member 120 includes a first cooling fan slot 154 near the opening to an air duct input 60 and a second cooling fan slot 156 near the opening to an air duct output 62 (FIGS. 5A and 5B). In a most preferred embodiment, the first member comprises more than two cooling fan slots 150.

The first member 120 may further comprise one or more support walls 158. The support walls 158 are typically disposed adjacent to the bottom wall 134 and are typically perpendicular to the bottom wall 134. The height of the support walls 158 may be the same as the height of the edges of the bottom wall 134. The support walls 158 are disposed adjacent to the first and second cooling fan slots 154, 156 and provide lateral support to the cooling fans 40 when cooling fans 40 are disposed within the first and second cooling fan slots 154, 156.

The second member 160 comprises a front panel 170, an exterior wall 178 and a pair of parallel ridges 180 (FIGS. 5A and 5B). The front panel 170 of the second member 160 is substantially flat along the lateral regions 172 and contains an upwardly curved central region 174. The bottom of the exterior wall 178 preferably comprises a second horizontal lip or protrusion 163.

A plurality of fastener channels 162 are preferably molded into the exterior wall 178 of the second member 160. Alternatively, a plurality of openings or apertures 162 may be disposed on the second horizontal lip 163. The fastener channels 162 are configured to receive the body of a fastener such as a bolt, rivet or clip (not shown). When the second member 160 is inserted into the first member 120, the apertures of the first member 120 and the fastener channels 162 of the second member 160 preferably are aligned. A fastener may therefore be inserted through the fastener channel 162 and aperture. The fastener may be used to secure the first and second members 120, 160 together. For example, a bolt may be inserted through the fastener channel 162 of the second member 160 and through the aperture of the first member 120. A nut (not shown) may then be attached to the bolt to secure the first and second members 120, 160 together.

The parallel ridges 180 define a central channel 182 (FIG. 5A). The central channel 182 is dimensioned to receive the repeater 70 and the power regulator 60. Preferably, the width W_{E} of the central channel 182 is substantially the same as the width W_{F} of the repeater 70 and/or power regulator 60 such that the repeater 70 and power regulator 60 fit securely within the central channel 182. The width W_{E} of the central channel 182 may be between about 3.5 and 6.5 inches. The height of the parallel ridges 180 of the central channel 182 may vary, but preferably the height is between about 0.5 to 3.5 inches. In a most preferred embodiment, the height of the parallel ridges 180 is between about 0.5 inches and 2 inches. In this embodiment, air may circulate more easily around the repeater unit 70 and power regulator 60. The parallel ridges 180 may extend from the bottom wall 190 towards the top wall 198. The ends of the parallel ridges 180 preferably are located approximately 1 to 5 inches from the top wall 198. When the first and second members 120, 160 are joined together, the support walls 158 of the first member 120 are preferably disposed laterally in relation to the parallel ridges 180. That is, the parallel ridges 180 are disposed more centrally than the support walls 158 (FIGS. 5A and 6).

The central portion of the bottom wall 190 of the second member 160 may include an extended region 184 (FIGS. 5B and 6). The extended region 184 has a substantially vertical wall 186 which extends out from the exterior wall 178. The back portion 188 of the extended region 184 includes a curved groove 168 which is configured to receive one or more RF cables 10, 20. The extended region 184 juts out from the exterior wall 178 and creates a small gap 166 between the vertical wall 186 and the bottom wall 134 of the first member 120 when the first and second members 120, 160 are joined together. This gap 166 is configured to receive a portion of the one or more RF cables 10, 20 that connect the antennas 200, 300 and the repeater 70. As described further below, a RF cable 10, 20 is inserted through the curved groove 168 of the second member 160 and threaded through the recess 138 of the first member 120. The RF cable 10, 20 can then be coupled with the repeater 70.

The sides of the bottom wall 190 each comprise a vented opening 60, 62 which is aligned with an interior chamber or plenum 164 of the enclosure (FIGS. 3, 5A and 5B). In operation, the cooling fans 40 motivate air (direction of airflow shown by arrows in FIG. 3) through the plenum 164 by drawing external air through the first vented opening, or air duct input 60, and directing the air out through the second vented opening, or air duct output 62. This creates an air circulation system which cools the electronic equipment and reduces the humidity within the enclosure 110. Alternatively, the bottom wall 190 may comprise a pair of openings that are not vented. The openings would therefore allow air to freely travel into and out of the plenum 164.

Preferably the exterior wall 178 of the second member 160 is located laterally of the exterior wall 130 of the first member when the first member 120 and second member 160 are joined together. Thus, as shown in FIG. 5B, when the first and second members 120, 160 are joined, the second member 160 covers the first member 120 such that the only portion of the first member 120 which is exposed is the back panel 124.

The exterior walls 178 of the enclosure define a U-shaped interior chamber or plenum 164 which extends along the sides 192 and the top portion 194 of the enclosure 110 (FIG. 5A). The plenum 164 is designed to allow air to circulate within the enclosure 110. This allows for the cooling of the repeater 70 and power regulator 60 and also reduces the humidity within the enclosure 110. Preferably, the plenum 164 is between about 1 and 5 inches wide at all points. The interior chamber or plenum 164 may further include a plurality of heat sinks 50 which assist in cooling the electronic equipment (FIG. 3).

The cooling fans 40 are configured to motivate air flow from outside the enclosure through the interior chamber or plenum 164 (FIG. 3). A first cooling fan 40 generally blows or motivates external air into the plenum 164 via the air duct input 60. A second cooling fan 40 preferably blows air out of the plenum 164 through the air duct output 62. A third cooling fan 40 generally pulls or motivates air up and over the repeater 70 and power regulator 60, and tends to blow air towards the second cooling fan 40. In this embodiment, the third cooling fan 40 may blow air across the heat sinks 50. In a further embodiment, additional cooling fans 40 may be disposed within the enclosure 110 to increase cooling of the repeater 70 and power regulator 60.

A controller 25 may be coupled with the repeater unit 100. The controller may be coupled with the repeater 70 or another portion of the repeater unit 100. The controller is adapted to monitor the temperature and the humidity within the enclosure 110. The controller 25 may be in communication with the cooling fans and configured to adjust the speed of the cooling fans based on the temperature and humidity within the enclosure 110.

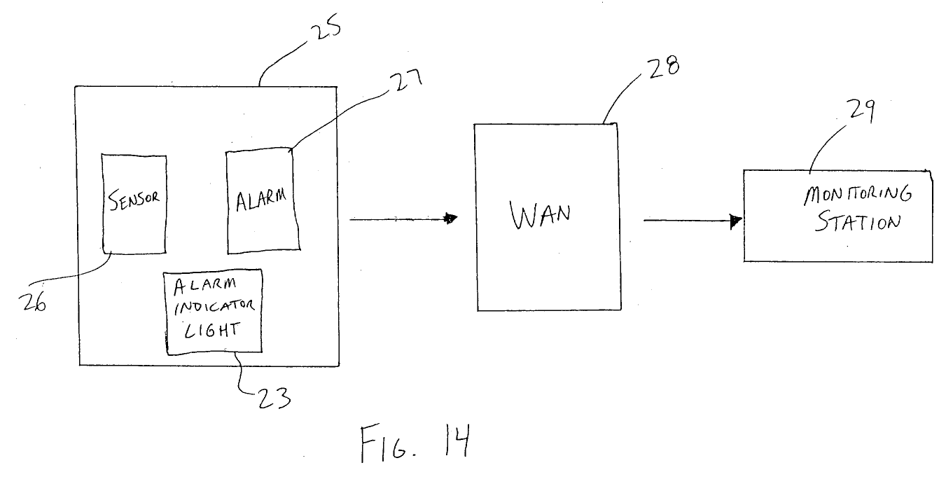

Turning to FIG. 14, the repeater unit 100 may further include a monitoring system 35. The monitoring system 35 may comprise one or more sensors 26 which are coupled with the cooling fans 40, controller 25, power regulator 60 and/or repeater 70 of the repeater unit 100. The sensors 26 are configured to detect problems or malfunctions with the operation of the components of the repeater unit 100. The monitoring system also comprises an alarm 27 that is configured to communicate with a central monitoring station 29. The alarm 27 may be able to communicate with a central monitoring station via a wide area network (WAN) 28 such as a cellular or satellite based system. In a preferred embodiment, the WAN 28 is a cellular system, and the monitoring system uses the first antenna 200 and/or the second antenna 300 to transmit an alarm signal when a malfunction is detected by the sensors 26.

The monitoring system also include one or more alarm indicator lights 23. When the repeater 70 and/or other components of the repeater unit 100 are functioning properly, one of the alarm indicator lights 23 of a specific color may be on. For example, a green light may be used to indicate that the system is functioning properly. When the sensors 26 detect a malfunction, a red alarm indicator light 23 may be illuminated.

The repeater unit 100 may also comprise a power outlet 90 which may connect the repeater unit 100 to the photocell adapter 600 as described further below. The side wall 196 or top wall 198 of the enclosure may comprise a power cord aperture (not shown) that is configured to receive a power cord 30 (FIGS. 1 and 3). Alternatively, the power cord 30 may be inserted through the bottom wall 190 of the enclosure 110 in a similar fashion as the RF cables 10, 20.

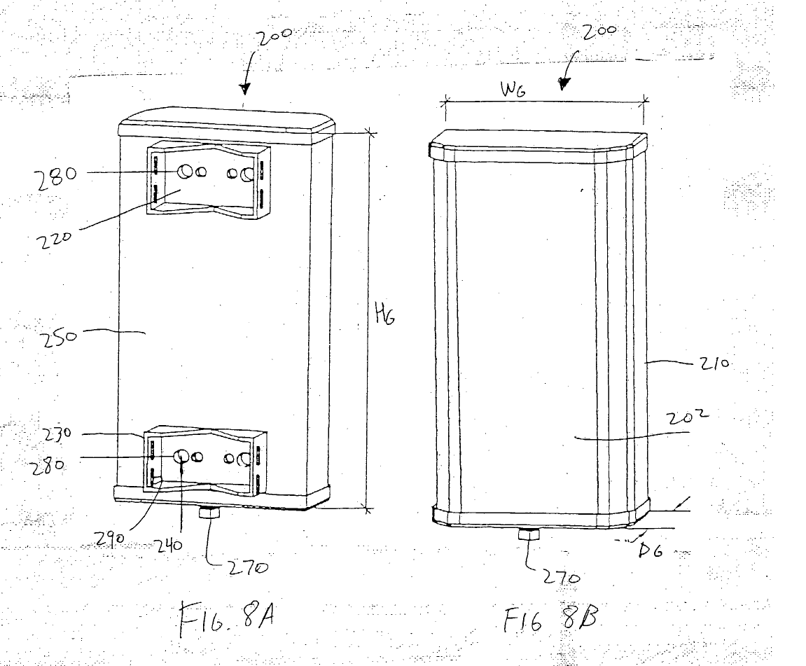

The first antenna 200 may comprise a decibel or directional antenna. The first antenna 200 may be in communication with the repeater unit 100 via a first RF coaxial cable 10 (FIG. 1). The weight of the first antenna 200 is preferably less than about 2 pounds and most preferably is substantially 1.8 pounds. Typically the height H_{G} of the first antenna is substantially 12 inches or less and the width of the first antenna is approximately 6.1 inches (FIGS. 8A and 8B). In a preferred embodiment, the surface area of the front wall 202 of the first antenna 200 is approximately 0.5 square feet. In a preferred embodiment, the reflector screen (not shown) of the first antenna 200 is made of a metal such as aluminum. The radiator (not shown) of the first antenna 200 is preferably made of a metal such as brass or aluminum. The radome 210 of the first antenna 200 is preferably comprised of PVC (UV resistant), high impact plastic, or fiberglass. The back wall 250 and radome 210 of the first antenna 200 may be colored to match the light standard 400 and/or repeater unit 100, or may be white, brown, gray, or beige. The first antenna 200 preferably includes an aperture or opening 270 dimensioned to receive a first RF cable 10 (FIGS. 1 and 8). As discussed further below, the back wall 250 of the first antenna 200 preferably comprises a first bracket 280 that is configured to engage a second bracket 112 mounted on the repeater unit 100.

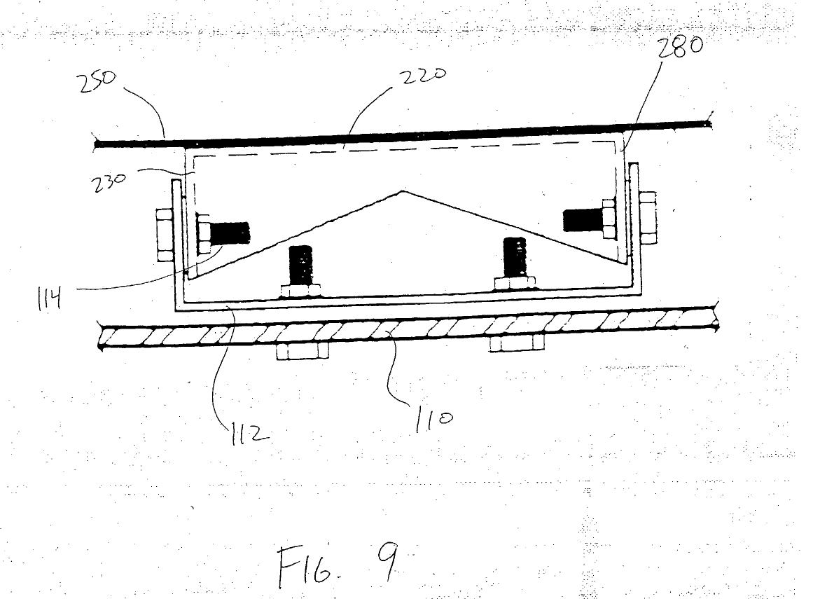

The repeater unit 100 and the first antenna 200 may be coupled and vertically mounted on the light standard 400 (FIG. 1). The repeater unit 100 and the first antenna 200 may be coupled by inserting one or more bolts 114 through adjoining brackets 112, 280 of the repeater unit 100 and the first antenna 200 (FIG. 9). In a preferred embodiment the back wall 250 of the first antenna 200 comprises a pair of first brackets 280. Alternatively, the back wall 250 may comprise a single bracket 280 or three or more brackets 280 that are configured to engage corresponding brackets 112 located on the repeater unit 100. The vertical wall 220 of each first bracket 280 may comprise one or more apertures 240 that are configured to receive a fastener 114 such as a clip, rivet, or bolt (FIGS. 8 and 9). A fastener 114 may be inserted through a corresponding opening in the back wall 250 of the first antenna 200 and then through the aperture 240 of the first bracket 280. The fastener 114 may then be tightened which secures the bracket 280 in a fixed position. In an alternative embodiment, the bracket 280 may be fixed to the back wall 250 via an adhesive such as glue. The lateral walls 230 of the first bracket 280 preferably comprise a plurality of apertures 290. The apertures 290 may be configured to receive the body of a fastener 114 such a clip, rivet, or bolt.

A second bracket 112 may be bolted or fixed to the enclosure 110 of the repeater unit 100. The second bracket 112 may comprise a plurality of apertures that are configured to receive a fastener 114 such as a clip, rivet, or bolt. In operation, a bolt may be inserted through the aperture of the second bracket 112 and an aperture 290 of the first bracket 280 and into a corresponding aperture on the second bracket. The bolt may then be secured by screwing a nut into the bolt. Preferably the depth of the first and second brackets 112, 280 when coupled together is less than 2 inches.

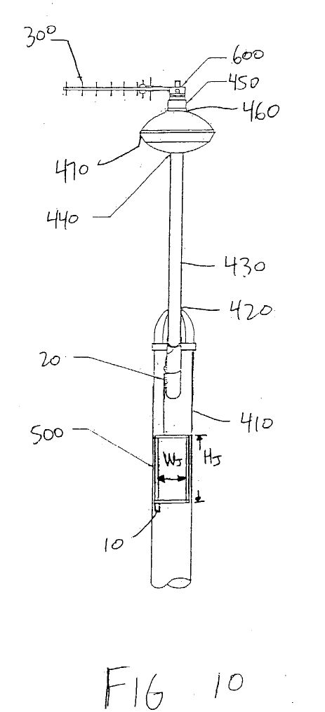

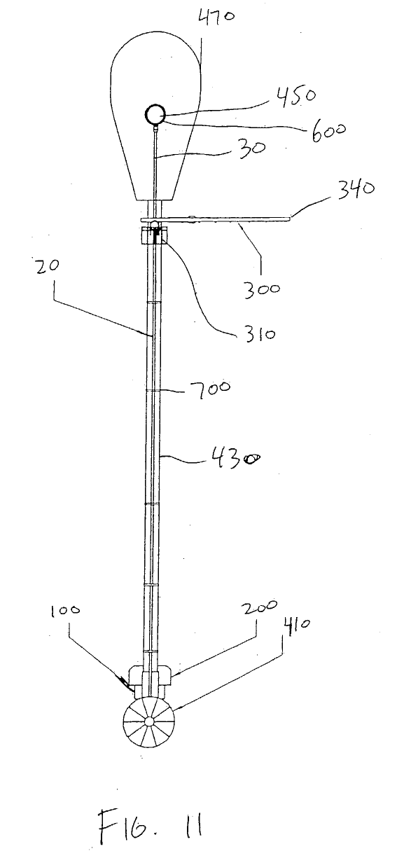

When coupled together, the first antenna 200 and repeater unit 100 form a mountable unit 500 (FIG. 1). The mountable unit 500 preferably has a weight that is equal to or less than about 20 pounds. The wind load, or surface area, of the mountable unit 500 is preferably about 1 square foot or less on each side. The height H_{J} of the mountable unit 500 is about 12 inches or less and the width W_{J} of the mountable unit 500 is typically about 10 inches or less (FIG. 10). The depth D_{J} of the mountable unit 500 is preferably in the range of about 4 to 10 inches and most preferably is in the range of about 6 to 9 inches.

The repeater unit 100 is mounted to the vertical pole 410 of the light standard 400. Typically, the repeater unit 100 is mounted within the top 5 feet of the light standard 400. In a preferred embodiment, the repeater unit 100 is mounted at least about 1.5 feet from the top 420 of the light standard pole 410. The repeater unit 100 may be mounted to the light standard pole 410 by one or more fasteners 510 such as tension bands, clamps, clasps, clips, or the like. The fastener 510 may be a stainless steel clamp. In a preferred embodiment, the top or bottom panel 170, 124 of the enclosure 110 comprises a mounting bracket or mounting aperture 116 (FIG. 4). The mounting bracket or aperture 116 may then be coupled with the fastener 510 in order to secure the repeater unit 100 to the light standard pole 410.

The repeater system also includes a second antenna 300. The second antenna 300 is in communication with the repeater unit 100 via a second RF coaxial cable 30. The second antenna 300 preferably is a stick antenna or a yagi antenna. In a preferred embodiment, the yagi antenna is approximately 10 to 30 inches long, and most preferably is in the range of 14 to 20 inches long. The yagi antenna is preferably between about 2 and 5 inches wide, and most preferably substantially 4 inches wide. The diameter of the yagi antenna may be substantially 1 inch. The weight of the yagi antenna is preferably less than about 3 pounds. However, the dimensions of the yagi antenna may vary depending on the application.

The second antenna 300 may be mounted to the light standard arm 430 by a second antenna bracket 310 (FIG. 1). The second antenna 300 may be positioned at any point along the light standard arm 430. In a preferred embodiment, the second antenna 300 is disposed adjacent to and above the light 440. The second antenna bracket 310 may comprise a vertical support 320 that is mounted to the light standard arm 430 by one or more U-shaped bolts or other fasteners (not shown). The second antenna 300 may then be secured to the vertical support 320 by a fastener such as a screw, rivet, clip or bolt (not shown). In a preferred embodiment, the second antenna 300 extends horizontally in relation to the ground (FIG. 10). In this embodiment, the second antenna 300 extends approximately 1 to 10 inches above the uppermost point 460 of the light standard arm 430. Preferably, the second antenna 300 extends 6 inches or less above the uppermost point 460 of the light standard arm 430 (FIG. 1). The second antenna 300 generally extends horizontally or laterally from the light standard arm 430 such that the tip 340 of the second antenna extends approximately 6 to 30 inches past the most lateral portion 470 of the light standard arm 430. Alternatively, the second antenna 300 may extend vertically upward, vertically downward, or in any other direction.

The repeater system may be powered by the photocell 450 of the light standard 400 (FIG. 1). Preferably, the system includes a photocell adapter 600 that may be coupled to the photocell 450 of the light standard 400. Typically, the photocell 450 is located above the light 440 on the light standard arm. The photocell adapter 600 is connected to the power cord 30. As described above, the power cord 30 may be connected to a power cord outlet 90 disposed within the repeater unit 100 (FIG. 3). The photocell adapter 600 provides the power source for the repeater 70, power regulator 60 and cooling fans 40 of the repeater unit 100. Preferably, the voltage supplied is approximately 6.7 Vdc and the current is substantially 1.2 A typ. The voltage and current supplied may vary depending on the electronic equipment within the repeater unit 100. In a most preferred embodiment, the electronic equipment within the repeater unit 100 does not require more than about 1.5 amps of operational current or about 2 amps of start up current. Alternatively, the repeater system may comprise one or more solar panels (not shown) affixed to the light standard 400.

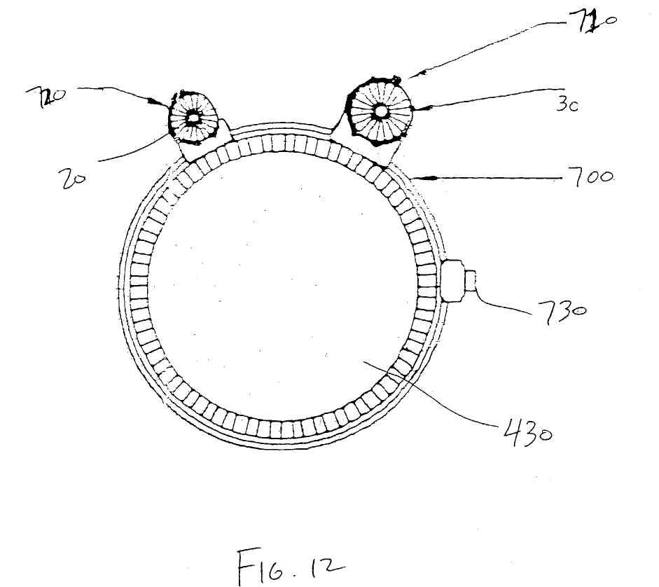

In a preferred embodiment, the power cord 30 and second RF cable 20 are secured to the light standard pole 410 and light standard arm 430 by a plurality of fasteners 700 such as clamps, tension bands, clips, clasps, or the like (FIG. 12). Preferably, the fasteners 700 include two rings, apertures, or extensions 710, 720 that are configured to receive either the power cord 30 or the RF cable 20. The power cord 30 may be inserted into a first ring 710 and the second RF cable 20 may be inserted into the second ring 720. The fastener 700 may also have an adjustment clip 730 which allows the fastener 700 to be tightened more securely to the light standard pole 400 or light standard arm 410.

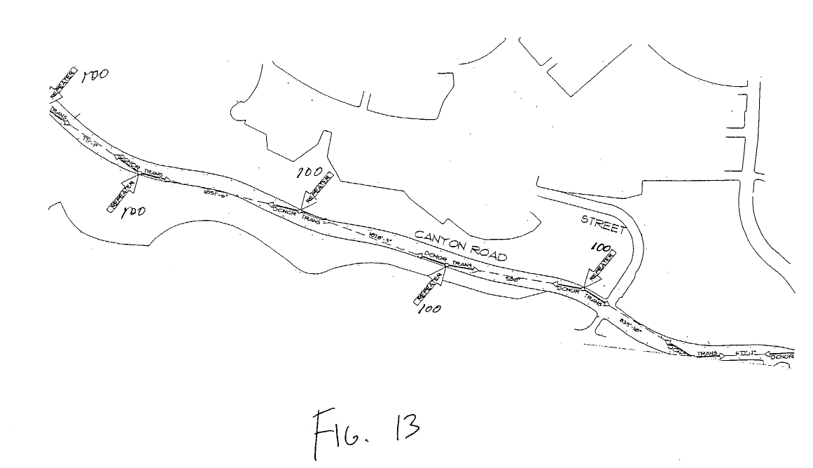

In use, the repeater system of the present invention may be mounted to several light standards (FIG. 13). Preferably, the repeater systems are positioned such that they provide a continuous signal network between larger antennas and/or base stations. The number of repeater systems that are necessary to provide adequate coverage to an area will depend on several factors such as the presence of hills, slopes, or the like.

While the invention is susceptible to various modifications and alternative forms, specific embodiments thereof have been shown in the drawings and herein described in detail. It should be understood, however, that the invention is not to be limited to the particular form disclosed, but to the contrary, the invention is to cover all modifications, equivalents, and alternatives falling within the spirit and scope of the appended claims.

What is claimed:

1. A repeater system for telecommunications networks dimensioned to be mounted on a pole, comprising:
a first antenna;
a repeater unit including a repeater, wherein the repeater unit has a weight less than 20 pounds;
a first RF cable connecting the first antenna and the repeater unit;
a second antenna;
a second RF cable connecting the repeater unit and the second antenna;
a photocell adapter; and
a power cord connecting the repeater unit and the photocell adapter.

2. The repeater system of claim 1, wherein the first antenna is a decibel antenna.

3. The repeater system of claim 1, wherein the second antenna is a yagi antenna.

4. The repeater system of claim 1, wherein the repeater unit further comprises a plurality of fans.

5. The repeater system of claim 1, wherein the repeater unit further comprises at least one heat sink.

6. The repeater system of claim 1, wherein the repeater unit further comprises a power regulator.

7. The repeater system of claim 1, wherein the repeater unit further comprises a power plug receptor.

8. The repeater system of claim 1, wherein the weight of the repeater unit is less than 18 pounds.

9. The repeater system of claim 1, wherein the repeater unit and the first antenna are coupled to form a mountable unit.

10. The repeater system of claim 9, wherein the weight of the mountable unit is less than 20 pounds.

11. The repeater system of claim 9, wherein the surface area of the mountable unit is less than 1 square foot on each side.

12. The repeater system of claim 1, wherein the weight of the first antenna is less than 2 pounds.

13. The repeater system of claim 1, wherein the surface area of the first antenna is less than 1 square foot on each side.

14. The repeater system of claim 1, wherein the surface area of the repeater unit is less than 1 square foot on each side.

15. The repeater system of claim 1, wherein the height of the first antenna is 12 inches or less.

16. The repeater system of claim 1, wherein the width of first antenna is less than 6.5 inches.

17. The repeater system of claim 1, wherein the depth of the first antenna is less than 3 inches.

18. The repeater system of claim 1, wherein the second antenna is mounted to a light standard arm by a second antenna bracket.

19. The repeater system of claim 1, wherein the photocell adapter provides start up current of 2 amps or less.

20. The repeater system of claim 1, wherein the photocell adapter provides operational current of 1.5 amps or less.

21. The repeater system of claim 1, wherein the repeater unit further comprises a monitoring system adapted to communicate with a remote monitoring station through a cellular network, wherein the monitoring system includes a plurality of sensors and an alarm.

22. A repeater unit for telecommunications networks, comprising:
a power regulator;
a repeater;
a plurality of fans;
at least one heat sink; and
an outer housing defining a chamber; and
wherein the weight of the repeater unit is less than 20 pounds.

23. The repeater unit of claim 22, wherein the weight of the repeater unit is less than 18 pounds.

24. The repeater unit of claim 22, wherein the surface area of the repeater unit is less than 1 square foot on each side.

25. The repeater unit of claim 22, further comprising a power plug receptor.

26. The repeater unit of claim 22, wherein the height of the outer housing is less than 12 inches.

27. The repeater unit of claim 22, wherein the height of the outer housing is substantially 9.5 inches.

28. The repeater unit of claim 22, wherein the width of the outer housing is less than 12 inches.

29. The repeater unit of claim 22, wherein the width of the outer housing is less than 9.5 inches.

30. The repeater unit of claim 22, wherein the depth of the outer housing is less than 3.5 inches.

31. The repeater unit of claim 22, wherein the repeater unit further comprises a monitoring system adapted to communicate with a remote monitoring station through a cellular network, wherein the monitoring system includes a plurality of sensors and an alarm.

32. A repeater unit, comprising:
an enclosure;
a repeater disposed within a central portion of the enclosure;
a power regulator disposed within the central portion of the enclosure;
a plenum disposed within the enclosure, the plenum having an inlet and at least one outlet;
a plurality of fans disposed within the enclosure configured to force air through the plenum; and
one or more heat sinks disposed with the enclosure.

33. The repeater unit of claim 32, wherein one of the plurality of fans is disposed adjacent to the inlet.

34. The repeater unit of claim 32, wherein one of the plurality of fans is disposed adjacent to the outlet.

35. The repeater unit of claim 32, further comprising one or more heat sinks disposed within the enclosure.

36. The repeater unit of claim 32, further comprising a power outlet disposed within the enclosure.

37. The repeater unit of claim 32, wherein the weight of the repeater unit is less than 20 pounds.

38. The repeater unit of claim 32, wherein the weight of the repeater unit is less than 18 pounds.

39. The repeater unit of claim 32, wherein the enclosure further comprises a plurality of fan slots each dimensioned to receive a fan.

40. The repeater unit of claim 32, wherein the enclosure further comprises parallel ridges which define a central channel, the central channel being dimensioned to receive the repeater and the power regulator.

41. A mountable unit for telecommunications networks, comprising:
a first antenna coupled to the repeater unit;
a repeater unit, the repeater unit having a repeater, a power regulator, a plurality of cooling fans, one or more heat sinks, and an enclosure defining a plenum;
a first RF cable connecting the first antenna and the repeater;
wherein the weight of the mountable unit is 20 pounds or less; and
wherein the surface area of the mountable unit on each side is less than 1 square foot.

42. The mountable unit of claim 41, wherein the mountable unit is configured to be mounted on a street light pole.

43. The mountable unit of claim 42, wherein the mountable unit is mounted within the top 5 feet of the street light pole.

44. A method of providing a telecommunications signal, comprising:
mounting a first repeater system to a first light standard, the first repeater system including an antenna and a repeater unit, wherein the repeater unit comprises a repeater, a plurality of cooling fans, one or more heat sinks, a power regulator, wherein the weight of the repeater system is less than 18 pounds; and
mounting a second repeater system to a second light standard, the second repeater system including an antenna and a repeater unit, wherein the repeater unit comprises a repeater, a plurality of cooling fans, one or more heat sinks, a power regulator, wherein the weight of the repeater system is less than 18 pounds.
